(19) United States
(12) Patent Application Publication
(10) Pub. No.: US 2015/0156007 A1
(43) Pub. Date: Jun. 4, 2015

(54) LINK ADJUSTING METHOD AND APPARATUS

(71) Applicant: Huawei Technologies Co., Ltd., Shenzhen (CN)

(72) Inventors: Shuangwu XU, Shenzhen (CN); Tianxin WANG, Shenzhen (CN); Yongjie SHI, Shenzhen (CN)

(21) Appl. No.: 14/555,067

(22) Filed: Nov. 26, 2014

(30) Foreign Application Priority Data
Nov. 29, 2013 (CN) 201310631315.1

(51) Int. Cl. H04L 7/00

(52) U.S. Cl. CPC H04L 7/0016

(57) ABSTRACT

The present invention discloses a link adjusting method and apparatus, where the method includes: increasing or reducing, by a first chip, a link between the first chip and a second chip; acquiring, by the first chip, an unchanged link between the first chip and the second chip; sending, by the first chip, an adjustment request message to the second chip, and sending, to the second chip, service data between the first chip and the second chip by using the unchanged link, so that the second chip synchronizes and aligns the link between the first chip and the second chip, and the second chip executes a service between the first chip and the second chip. The apparatus includes: an adjusting module, an acquiring module, and a sending module. The present invention may adjust a link under a circumstance that service data transmission between chips is not interrupted.

### CROSS-REFERENCE TO RELATED APPLICATION

This application claims priority to Chinese Patent Application No. 201310631315.1, filed on Nov. 29, 2013, which is hereby incorporated by reference in its entirety.

### TECHNICAL FIELD

The present invention relates to the communications field, and in particular, to a link adjusting method and apparatus.

### BACKGROUND

A communications device includes a chip controller and multiple chips, and multiple links are adopted to transmit data between chips. As the number of links increases, these links account for an increasingly large proportion in the power consumption of the entire chips. To save resources, links need to be adjusted according to data transmission, that is, some links are reduced when traffic of data transmission is low, and some links are increased when the traffic of data transmission is high.

At present, regarding any two chips included in a communications device, for ease of description, the two chips are referred to as a first chip and a second chip respectively. When the first chip needs to adjust a link between the first chip and the second chip, the first chip interrupts service data transmitted between the first chip and the second chip, and increases or reduces a link between the first chip and the second chip; the first chip transmits control information to the second chip by using the link between the first chip and the second chip. After detecting that the first chip adjusts the link, a chip controller sends an adjustment command to the second chip. The second chip receives the control information and the adjustment command, and synchronizes and aligns the link between the second chip and the first chip according to the control information. After detecting that the second chip has completed a synchronization and alignment operation on the link between the first chip and the second chip, the chip controller sends a synchronization and alignment response message to the first chip. The first chip receives the synchronization and alignment response message, and transmits the service data by using the link between the first chip and the second chip.

During a process of implementing the present invention, the inventor finds that the prior art has at least the following problem:

When the link is adjusted, the first chip interrupts the service data transmitted between the first chip and the second chip, resulting in a service interruption between the first chip and the second chip.

### SUMMARY

To avoid an interruption of service data transmission between a first chip and a second chip during a link adjustment, the present invention provides a link adjusting method and apparatus. The technical solutions are as follows:

According to a first aspect, a link adjusting method is provided, where the method includes:

increasing or reducing, by a first chip, a link between the first chip and a second chip;

acquiring, by the first chip, an unchanged link between the first chip and the second chip; and

sending, by the first chip, an adjustment request message to the second chip, and sending, to the second chip, service data between the first chip and the second chip by using the unchanged link, so that the second chip synchronizes and aligns the link between the first chip and the second chip, and the second chip executes a service between the first chip and the second chip.

With reference to the first aspect, in a first possible implementation manner of the foregoing first aspect, the sending, by the first chip, an adjustment request message to the second chip, and sending, to the second chip, service data between the first chip and the second chip by using the unchanged link, include:

inserting, by the first chip, the adjustment request message into a custom field in an interface protocol packet, inserting the service data between the first chip and the second chip into a data field in the interface protocol packet, and sending, by using the unchanged link, the interface protocol packet to the second chip.

With reference to the first aspect, in a second possible implementation manner of the foregoing first aspect, the sending, by the first chip, an adjustment request message to the second chip, and sending, to the second chip, service data between the first chip and the second chip by using the unchanged link, include:

sending, by the first chip, the adjustment request message to the second chip through a universal serial interface between the first chip and the second chip; and

inserting, by the first chip, the service data between the first chip and the second chip into a data field in an interface protocol packet, and sending, by using the unchanged link, the interface protocol packet to the second chip.

With reference to the first possible implementation manner of the first aspect, in a third possible implementation manner of the foregoing first aspect, the custom field includes a multipurpose field and an in-band flow control field, and the adjustment request message includes an adjustment command and a first number of links, where the first number of links is the number of current links between the first chip and the second chip; and

the inserting, by the first chip, the adjustment request message into a custom field in an interface protocol packet, includes:

determining, by the first chip from the multipurpose field included in the interface protocol packet, a first field used to transmit adjustment control information and a second field used to transmit adjustment configuration information, and setting the first field to carry the adjustment command, and the second field to carry the first number of links; or

determining, by the first chip from the in-band flow control field included in the interface protocol packet, a first field used to transmit adjustment control information and a second field used to transmit adjustment configuration information, and setting the first field to carry the adjustment command, and the second field to carry the first number of links.

With reference to the first aspect, in a fourth possible implementation manner of the foregoing first aspect, the method further includes:

receiving, by the first chip by using the unchanged link, the interface protocol packet sent by the second chip, determining, from the multipurpose field included in the interface protocol packet, the first field used to transmit the adjustment control information, and extracting a synchronization and alignment response message from the first field; or

receiving, by the first chip by using the unchanged link, the interface protocol packet sent by the second chip, determining, from the in-band flow control field included in the interface protocol packet, the first field used to transmit the adjustment control information, and extracting a synchronization and alignment response message from the first field; or

receiving, by the first chip through the universal serial interface between the first chip and the second chip, a synchronization and alignment response message sent by the second chip.

According to a second aspect, a link adjusting method is provided, where the method includes:

when a first chip increases or reduces a link between the first chip and a second chip, receiving, by the second chip, an adjustment request message sent by the first chip, and receiving service data between the first chip and the second chip by using an unchanged link, where the service data is sent by the first chip; and

synchronizing and aligning, by the second chip, the link between the first chip and the second chip according to the adjustment request message, and executing a service between the first chip and the second chip according to the service data between the first chip and the second chip.

With reference to the second aspect, in a first possible implementation manner of the foregoing first aspect, the receiving, by the second chip, an adjustment request message sent by the first chip, and receiving service data between the first chip and the second chip by using an unchanged link, where the service data is sent by the first chip, include:

receiving, by the second chip by using the unchanged link, an interface protocol packet sent by the first chip, and extracting, from the interface protocol packet, the adjustment request message and the service data between the first chip and the second chip.

With reference to the first possible implementation manner of the second aspect, in a second possible implementation manner of the foregoing second aspect, the extracting, from the interface protocol packet, the adjustment request message and the service data between the first chip and the second chip, includes:

determining, by the second chip from a multipurpose field included in the interface protocol packet, a first field used to transmit adjustment control information and a second field used to transmit adjustment configuration information, extracting an adjustment command from the first field, extracting a first number of links from the second field, and extracting the service data between the first chip and the second chip from a data field included in the interface protocol packet; or

determining, by the second chip from an in-band flow control field included in the interface protocol packet, a first field used to transmit adjustment control information and a second field used to transmit adjustment configuration information, extracting an adjustment command from the first field, extracting a first number of links from the second field, and extracting the service data between the first chip and the second chip from a data field included in the interface protocol packet.

With reference to the second aspect, in a third possible implementation manner of the foregoing second aspect, the receiving, by the second chip, an adjustment request message sent by the first chip, and receiving service data between the first chip and the second chip by using an unchanged link, where the service data is sent by the first chip, include:

receiving, by the second chip through a universal serial interface between the first chip and the second chip, the adjustment request message sent by the first chip; and

receiving, by using the unchanged link, an interface protocol packet sent by the first chip, and extracting the service data between the first chip and the second chip from a data field included in the interface protocol packet.

With reference to the second aspect, in a fourth possible implementation manner of the foregoing second aspect, the synchronizing and aligning, by the second chip, the link between the first chip and the second chip according to the adjustment request message, includes:

comparing a second number of links with the first number of links, where the second number of links is the number of links between the first chip and the second chip before the first chip adjusts the link;

if the second number of links is smaller than the first number of links, determining that the first chip increases a link, and acquiring the unchanged link and a newly-added link between the first chip and the second chip; and

synchronizing and aligning the newly-added link with the unchanged link.

With reference to the second aspect, in a fifth possible implementation manner of the foregoing second aspect, after the synchronizing and aligning, by the second chip, the link between the first chip and the second chip according to the adjustment request message, the method further includes:

determining, by the second chip from the multipurpose field included in the interface protocol packet, the first field used to transmit the adjustment control information, setting the first field to carry a synchronization and alignment response message, and sending the interface protocol packet to the first chip by using the unchanged link; or

determining, by the second chip from the in-band flow control field included in the interface protocol packet, the first field used to transmit the adjustment control information, setting the first field to carry a synchronization and alignment response message, and sending the interface protocol packet to the first chip by using the unchanged link; or

sending, by the second chip, a synchronization and alignment response message through the universal serial interface between the first chip and the second chip.

According to a third aspect, a link adjusting apparatus is provided, where the apparatus includes:

an adjusting module, configured to increase or reduce a link between a first chip and a second chip;

an acquiring module, configured to acquire an unchanged link between the first chip and the second chip; and

a sending module, configured to send an adjustment request message to the second chip, and send, to the second chip, service data between the first chip and the second chip by using the unchanged link, so that the second chip synchronizes and aligns the link between the first chip and the second chip, and the second chip executes a service between the first chip and the second chip.

With reference to the third aspect, in a first possible implementation manner of the foregoing third aspect, the sending module is configured to insert the adjustment request message into a custom field in an interface protocol packet, insert the service data between the first chip and the second chip into a data field in the interface protocol packet, and send the interface protocol packet to the second chip by using the unchanged link.

With reference to the third aspect, in a second possible implementation manner of the foregoing third aspect, the sending module includes:

a sending unit, configured to send the adjustment request message to the second chip through a universal serial interface between the first chip and the second chip; and

an inserting and sending unit, configured to insert the service data between the first chip and the second chip into a data field in an interface protocol packet, and send the interface protocol packet to the second chip by using the unchanged link.

With reference to the first possible implementation manner of the third aspect, in a third possible implementation manner of the foregoing third aspect, the custom field includes a multipurpose field and an in-band flow control field, and the adjustment request message includes an adjustment command and a first number of links, where the first number of links is the number of current links between the first chip and the second chip; and

the sending module includes:

a first determining and setting unit, configured to determine, from the multipurpose field included in the interface protocol packet, a first field used to transmit adjustment control information and a second field used to transmit adjustment configuration information, and set the first field to carry the adjustment command, and the second field to carry the first number of links; or

a second determining and setting unit, configured to determine, from the in-band flow control field included in the interface protocol packet, a first field used to transmit adjustment control information and a second field used to transmit adjustment configuration information, and set the first field to carry the adjustment command, and the second field to carry the first number of links.

With reference to the third aspect, in a fourth possible implementation manner of the foregoing third aspect, the apparatus further includes:

a first receiving module, configured to receive, from the unchanged link, the interface protocol packet sent by the second chip, determine, from the multipurpose field included in the interface protocol packet, the first field used to transmit the adjustment control information, and extract a synchronization and alignment response message from the first field; or

a second receiving module, configured to receive, from the unchanged link, the interface protocol packet sent by the second chip, determine, from the in-band flow control field included in the interface protocol packet, the first field used to transmit the adjustment control information, and extract the synchronization and alignment response message from the first field; or

a third receiving module, configured to receive, through the universal serial interface between the first chip and the second chip, the synchronization and alignment response message sent by the second chip.

According to a fourth aspect, a link adjusting apparatus is provided, where the apparatus includes:

a receiving module, configured to, when a first chip increases or reduces a link between the first chip and a second chip, receive an adjustment request message sent by the first chip, and receive service data between the first chip and the second chip by using an unchanged link, where the service data is sent by the first chip; and

a synchronizing and aligning module, configured to synchronize and align the link between the first chip and the second chip according to the adjustment request message, and execute a service between the first chip and the second chip according to the service data between the first chip and the second chip.

With reference to the fourth aspect, in a first possible implementation manner of the foregoing fourth aspect, the receiving module is configured to receive, from the unchanged link, an interface protocol packet sent by the first chip, and extract the adjustment request message and the service data between the first chip and the second chip from the interface protocol packet.

With reference to the first possible implementation manner of the fourth aspect, in a second possible implementation manner of the fourth aspect, the receiving module includes:

a first determining and extracting unit, configured to determine, from a multipurpose field included in the interface protocol packet, a first field used to transmit adjustment control information and a second field used to transmit adjustment configuration information, extract an adjustment command from the first field, extract a first number of links from the second field, and extract the service data between the first chip and the second chip from a data field included in the interface protocol packet; or

a second determining and extracting unit, configured to determine, from an in-band flow control field included in the interface protocol packet, a first field used to transmit adjustment control information and a second field used to transmit adjustment configuration information, extract an adjustment command from the first field, extract a first number of links from the second field, and extract the service data between the first chip and the second chip from a data field included in the interface protocol packet.

With reference to the fourth aspect, in a third possible implementation manner of the foregoing fourth aspect, the receiving module includes:

a receiving unit, configured to receive, through a universal serial interface between the first chip and the second chip, the adjustment request message sent by the first chip; and

a receiving and extracting unit, configured to receive, from the unchanged link, an interface protocol packet sent by the first chip, and extract the service data between the first chip and the second chip from a data field included in the interface protocol packet.

With reference to the fourth aspect, in a fourth possible implementation manner of the foregoing fourth aspect, the synchronizing and aligning module includes:

a comparing unit, configured to compare a second number of links with the first number of links, where the second number of links is the number of links between the first chip and the second chip before the first chip adjusts the link;

an acquiring unit, configured to, if the second number of links is smaller than the first number of links, determine that the first chip increases a link, and acquire the unchanged link and a newly-added link between the first chip and the second chip; and

a synchronizing and aligning unit, configured to synchronize and align the newly-added link with the unchanged link.

With reference to the fourth aspect, in a fifth possible implementation manner of the foregoing fourth aspect, the apparatus further includes:

a first setting and sending module, configured to determine, from the multipurpose field included in the interface protocol packet, the first field used to transmit the adjustment control information, set the first field to carry a synchronization and alignment response message, and send the interface protocol packet to the first chip by using the unchanged link; or

a second setting and sending module, configured to determine, from the in-band flow control field included in the interface protocol packet, the first field used to transmit the adjustment control information, set the first field to carry a synchronization and alignment response message, and send the interface protocol packet to the first chip by using the unchanged link; or

a sending module, configured to send a synchronization and alignment response message through the universal serial interface between the first chip and the second chip.

In embodiments of the present invention, a first chip increases or reduces a link between the first chip and a second chip; the first chip acquires an unchanged link between the first chip and the second chip; the first chip sends an adjustment request message to the second chip, and sends, to the second chip, service data between the first chip and the second chip by using the unchanged link, so that the second chip synchronizes and aligns the link between the first chip and the second chip, and the second chip executes a service between the first chip and the second chip. When a link is adjusted, the service data is sent by using the unchanged link; therefore, the service between the first chip and the second chip is not interrupted.

### BRIEF DESCRIPTION OF DRAWINGS

FIG. 1 is a flowchart of a link adjusting method according to Embodiment 1 of the present invention;

FIG. 2 is a flowchart of a link adjusting method according to Embodiment 2 of the present invention;

FIG. 3 is a flowchart of a link adjusting method according to Embodiment 3 of the present invention;

FIG. 4 is a flowchart of a link adjusting method according to Embodiment 4 of the present invention;

FIG. 5 is a schematic structural diagram of a link adjusting apparatus according to Embodiment 5 of the present invention; and

FIG. 6 is a schematic structural diagram of a link adjusting apparatus according to Embodiment 6 of the present invention.

### DESCRIPTION OF EMBODIMENTS

To make the objectives, technical solutions, and advantages of the present invention clearer, the following further describes the embodiments of the present invention in detail with reference to the accompanying drawings.

### Embodiment 1

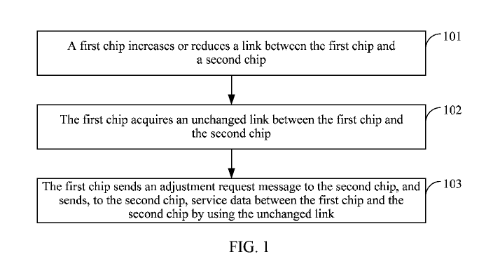

Referring to FIG. 1, this embodiment of the present invention provides a link adjusting method. The method includes:

Step 101: A first chip increases or reduces a link between the first chip and a second chip.

Step 102: The first chip acquires an unchanged link between the first chip and the second chip.

Step 103: The first chip sends an adjustment request message to the second chip, and sends, to the second chip, service data between the first chip and the second chip by using the unchanged link, so that the second chip synchronizes and aligns the link between the first chip and the second chip, and the second chip executes a service between the first chip and the second chip.

Preferably, that the first chip sends an adjustment request message to the second chip, and sends, to the second chip, service data between the first chip and the second chip by using the unchanged link, includes the following:

The first chip inserts the adjustment request message into a custom field in an interface protocol packet, inserts the service data between the first chip and the second chip into a data field in the interface protocol packet, and sends the interface protocol packet to the second chip by using the unchanged link.

Preferably, that the first chip sends an adjustment request message to the second chip, and sends, to the second chip, service data between the first chip and the second chip by using an unchanged link, includes the following:

The first chip sends the adjustment request message to the second chip through a universal serial interface between the first chip and the second chip.

The first chip inserts the service data between the first chip and the second chip into a data field in the interface protocol packet, and sends the interface protocol packet to the second chip by using the unchanged link.

Preferably, the custom field includes a multipurpose field and an in-band flow control field, and the adjustment request message includes an adjustment command and a first number of links, where the first number of links is the number of current links between the first chip and the second chip.

That the first chip inserts the adjustment request message into a custom field in an interface protocol packet includes:

determining, by the first chip from the multipurpose field included in the interface protocol packet, a first field used to transmit adjustment control information and a second field used to transmit adjustment configuration information, and setting the first field to carry the adjustment command, and the second field to carry the first number of links; or

determining, by the first chip from the in-band flow control field included in the interface protocol packet, a first field used to transmit adjustment control information and a second field used to transmit adjustment configuration information, and setting the first field to carry the adjustment command, and the second field to carry the first number of links.

Further, the method further includes:

receiving, by the first chip from the unchanged link, the interface protocol packet sent by the second chip, determining, from the multipurpose field included in the interface protocol packet, the first field used to transmit the adjustment control information, and extracting a synchronization and alignment response message from the first field; or

receiving, by the first chip by using the unchanged link, the interface protocol packet sent by the second chip, determining, from the in-band flow control field included in the interface protocol packet, the first field used to transmit the adjustment control information, and extracting a synchronization and alignment response message from the first field; or

receiving, by the first chip through the universal serial interface between the first chip and the second chip, a synchronization and alignment response message sent by the second chip.

In this embodiment of the present invention, a first chip increases or reduces a link between the first chip and a second chip; the first chip acquires an unchanged link between the first chip and the second chip; the first chip sends an adjustment request message to the second chip, and sends, to the second chip, service data between the first chip and the second chip by using the unchanged link, so that the second chip synchronizes and aligns the link between the first chip and the second chip, and the second chip executes a service between the first chip and the second chip. When a link is adjusted, the service data is sent by using the unchanged link; therefore, the service between the first chip and the second chip is not interrupted.

### Embodiment 2

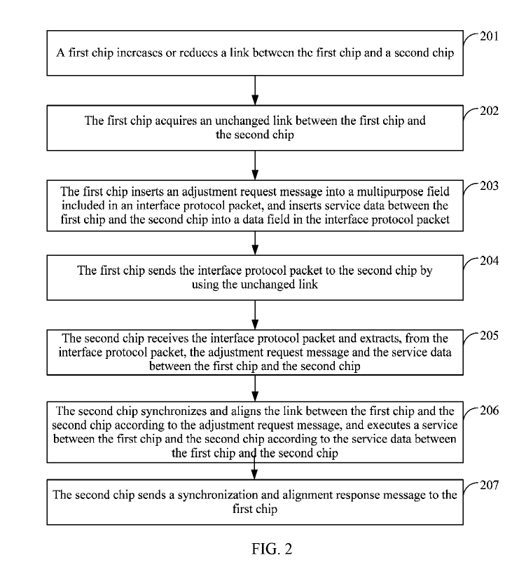

Referring to FIG. 2, this embodiment of the present invention provides a link adjusting method, which uses a multipurpose field included in a custom field in an interface protocol packet to transmit an adjustment request message. The method includes:

Step 201: A first chip increases or reduces a link between the first chip and a second chip.

There is at least one link that connects the first chip and the second chip. When the first chip needs to adjust the link between the first chip and the second chip, the first chip may increase or reduce the link between the first chip and the second chip.

The step may specifically be as follows: When the first chip increases a link between the first chip and the second chip, the first chip and the second chip increase a link at pins that is not occupied, and sequentially numbers the newly-added link according to mapping numbers of the links between the first chip and the second chip before the first chip increases the link; or when the first chip reduces a link between the first chip and the second chip, the first chip acquires a link whose mapping number is the last among links between the first chip and the second chip, and deletes the link whose mapping number is the last.

For example, pins of the first chip and the second chip include pins 0, 1, 2, 3, 4, and 5. Before the first chip increases a link, the mapping numbers of the links between the first chip and the second chip are Lane1, Lane2, Lane3, and Lane4, and these links occupy pins 0, 2, 3, and 4 respectively. Then unoccupied pins are pins 1 and 5 before the first chip increases the link. When the first chip increases one link, the first chip selects either of the unoccupied pins 1 and 5. A description is given by using pin 1 as an example. The first chip increases the one link at the pin 1 and sequentially numbers, according to the mapping numbers Lane1, Lane2, Lane3, and Lane4 of the links between the first chip and the second chip before the first chip increases the link, the newly-added link Lane5; or when the first chip reduces one link, the first chip acquires, among the links Lane1, Lane2, Lane3, and Lane4 between the first chip and the second chip before the link is reduced, the link Lane 4 whose mapping number is the last, and deletes the link Lane4.

Step 202: The first chip acquires an unchanged link between the first chip and the second chip.

When the first chip increases the link between the first chip and the second chip, the unchanged link acquired by the first chip is a link between the first chip and the second chip before the first chip increases the link; when the first chip reduces the link between the first chip and the second chip, the unchanged link acquired by the first chip is the link between the first chip and the second chip after the first chip reduces the link.

For example, when the first chip increases one link, the first chip acquires the unchanged links Lane1, Lane2, Lane3, and Lane4 between the first chip and the second chip; when the first chip reduces one link, the first chip acquires the unchanged links Lane1, Lane2, and Lane3 between the first chip and the second chip.

Step 203: The first chip inserts an adjustment request message into a multipurpose field included in an interface protocol packet, and inserts service data between the first chip and the second chip into a data field in the interface protocol packet.

Specifically, the first chip determines, from the multipurpose field included in the interface protocol packet, a first field used to transmit adjustment control information and a second field used to transmit adjustment configuration information, and sets the first field to carry an adjustment command, and the second field to carry a first number of links. The first chip inserts the service data between the first chip and the second chip into the data field in the interface protocol packet.

The multipurpose field included in the interface protocol packet is a custom field included in the interface protocol packet.

The adjustment request message includes the adjustment command and the first number of links, where the first number of links is the number of current links between the first chip and the second chip.

For example, refer to Table 1. The first field used to transmit the adjustment control information occupies two bits, that is, the 5^{th} bit and the 6^{th} bit in the multipurpose field, and the second field used to transmit the adjustment configuration information occupies five bits, that is, the 0^{th} bit to the 4^{th} bit in the multipurpose field. The first chip determines, from the multipurpose field included in the interface protocol packet, the first field used to transmit the adjustment control information and the second field used to transmit the adjustment configuration information, as shown in Table 1, and sets the first field to carry the adjustment command, and the second field to carry the first number of links. The first chip inserts the service data between the first chip and the second chip into the data field in the interface protocol packet.

TABLE 1

| | Multipurpose field | | | | | | | |
|---|---|---|---|---|---|---|---|---|
| Location | bit 7 | bit 6 | bit 5 | bit 4 | bit 3 | bit 2 | bit 1 | bit 0 |

| | | | |
|---|---|---|---|
| Bearer | Reserved | First field | Second field |
| informa- | | | |
| tion | | | |

The first field is invariably used to transmit the adjustment control information. When the first chip does not adjust a link, the first chip sets a binary instruction code of the first field to 00 indicating that there is no request/response; when the first chip adjusts a link, the first chip sets the binary instruction code of the first field to 01. The second field is a time division multiplexing field. When the first chip adjusts a link, the second field is used to transmit the adjustment configuration information, where the second field includes five bits and may carry a maximum of 32 types of adjustment configuration information. When the first chip does not adjust a link, the second field is used to transmit user-defined information.

In this example, the first number of links is 5, the binary instruction code of the first field is set to 01, and a binary instruction code of the second field is set to 00101.

Step 204: The first chip sends the interface protocol packet to the second chip by using the unchanged link.

For example, the first chip sends the interface protocol packet that carries an adjustment command 01, a first number 00101 of links, and the service data to the second chip by using the unchanged links Lane1, Lane2, Lane3, and Lane4.

Step 205: The second chip receives the interface protocol packet, and extracts, from the interface protocol packet, the adjustment request message and the service data between the first chip and the second chip.

Specifically, the second chip receives the interface protocol packet, determines, from the multipurpose field included in the interface protocol packet, the first field used to transmit the adjustment control information and the second field used to transmit the adjustment configuration information, extracts the adjustment command from the first field, extracts the first number of links from the second field, and extracts the service data between the first chip and the second chip from the data field included in the interface protocol packet.

For example, the second chip receives the interface protocol packet, determines, from the multipurpose field included in the interface protocol packet, the first field used to transmit the adjustment control information and the second field used to transmit the adjustment configuration information, as shown in Table 1, and extracts the adjustment command 01 from the first field, extracts the first number 00101 of links from the second field, and extracts the service data between the first chip and the second chip from the data field included in the interface protocol packet.

Step 206: The second chip synchronizes and aligns the link between the first chip and the second chip according to the adjustment request message, and executes a service between the first chip and the second chip according to the service data between the first chip and the second chip.

Specifically, the second chip compares a second number of links with the first number of links, where the second number of links is the number of links between the first chip and the second chip before the first chip adjusts the link; if the second number of links is smaller than the first number of links, it is determined that the first chip increases a link, and the unchanged link and the newly-added link between the first chip and the second chip are acquired, synchronizes and aligns the newly-added link with the unchanged link, and executes the service between the first chip and the second chip according to the service data between the first chip and the second chip.

If the second number of links is greater than the first number of links, the second chip determines that the first chip reduces a link. After the first chip reduces a link, links between the first chip and the second chip are unchanged links, and the unchanged links are links that have been synchronized and aligned. Therefore, when the first chip reduces a link, no synchronization and alignment is required, and only the service between the first chip and the second chip is executed according to the service data between the first chip and the second chip.

For example, the second chip compares the second number 4 of links with the first number 5 of links, where the second number 4 of links is the number of links between the first chip and the second chip before the first chip adjusts the link; the second chip learns by comparison that the second number 4 of links is smaller than the first number 5 of links, determines that the first chip increases a link, and acquires the unchanged links Lane1, Lane2, Lane3, and Lane4 and the newly-added link Lane5 between the first chip and the second chip; the second chip synchronizes and aligns the newly-added link Lane5 with the unchanged links Lane1, Lane2, Lane3, and Lane4, and executes the service between the first chip and the second chip according to the service data between the first chip and the second chip.

Step 207: The second chip sends a synchronization and alignment response message to the first chip.

Specifically, the second chip determines, from the multipurpose field included in the interface protocol packet, the first field used to transmit the adjustment control information, sets the first field to carry the synchronization and alignment response message, and sends the interface protocol packet to the first chip by using the unchanged link.

The second chip may send the synchronization and alignment response message to the first chip after synchronization and alignment are complete; the second chip may also send a synchronization response message to the first chip after synchronization is complete, and send an alignment response message to the first chip after alignment is complete.

For example, the second chip determines, from the multipurpose field included in the interface protocol packet, the first field used to transmit the adjustment control information, as shown in Table 1, and sets the binary instruction code of the first field to 11 that indicates the synchronization and alignment response message, and sends the interface protocol packet to the first chip by using the unchanged links Lane1, Lane2, Lane3, and Lane4.

In this embodiment of the present invention, a first chip increases or reduces a link between the first chip and a second chip; the first chip acquires an unchanged link between the first chip and the second chip; the first chip transmits an adjustment request message by using a multipurpose field included in a custom field in an interface protocol packet, and sends the adjustment request message to the second chip, and sends, to the second chip, service data between the first chip and the second chip by using the unchanged link, so that the second chip synchronizes and aligns the link between the first chip and the second chip, and the second chip executes a service between the first chip and the second chip. When a link is adjusted, the service data is sent by using the unchanged link; therefore, the service between the first chip and the second chip is not interrupted.

### Embodiment 3

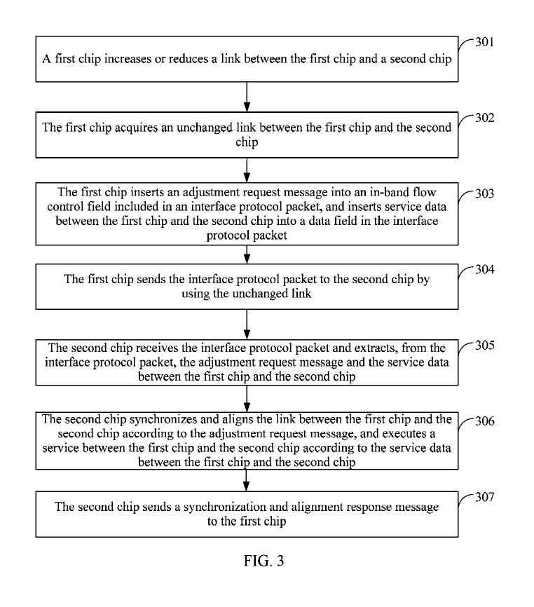

Referring to FIG. 3, this embodiment of the present invention provides a link adjusting method, which uses an in-band flow control field included in a custom field in an interface protocol packet to transmit an adjustment request message. The method includes:

Step 301: A first chip increases or reduces a link between the first chip and a second chip.

There is at least one link that connects the first chip and the second chip. When the first chip needs to adjust the link between the first chip and the second chip, the first chip may increase or reduce the link between the first chip and the second chip.

The step may specifically be as follows: When the first chip increases a link between the first chip and the second chip, the first chip increases the link at a pin of the second chip that is not occupied by the first chip, and sequentially numbers the newly-added link according to mapping numbers of the links between the first chip and the second chip before the first chip increases the link; or when the first chip reduces a link between the first chip and the second chip, the first chip acquires a link whose mapping number is the last among links between the first chip and the second chip, and deletes the link whose mapping number is the last.

For example, pins of the first chip and the second chip include pins 0, 1, 2, 3, 4, and 5. Before the first chip increases a link, the mapping numbers of the links between the first chip and the second chip are Lane1, Lane2, Lane3, and Lane4, and these links occupy pins 0, 2, 3, and 4 respectively. Then unoccupied pins are pins 1 and 5 before the first chip increases the link. When the first chip increases one link, the first chip selects either of the unoccupied pins 1 and 5. A description is given by using pin 1 as an example. The first chip increases the one link at the pin 1 and sequentially numbers, according to the mapping numbers Lane1, Lane2, Lane3, and Lane4 of the links between the first chip and the second chip before the first chip increases the link, the newly-added link Lane5; or when the first chip reduces one link, the first chip acquires, among the links with the mapping numbers of Lane1, Lane2, Lane3, and Lane4 between the first chip and the second chip before the link is reduced, the link Lane 4 whose mapping number is the last, and deletes the link Lane4.

Step 302: The first chip acquires an unchanged link between the first chip and the second chip.

When the first chip increases a link between the first chip and the second chip, the unchanged link acquired by the first chip is a link between the first chip and the second chip before the first chip increases the link; when the first chip reduces the link between the first chip and the second chip, the unchanged link acquired by the first chip is the link between the first chip and the second chip after the first chip reduces the link.

For example, when the first chip increases one link, the first chip acquires the unchanged links Lane1, Lane2, Lane3, and Lane4 between the first chip and the second chip; when the first chip reduces one link, the first chip acquires the unchanged links Lane1, Lane2, and Lane3 between the first chip and the second chip.

Step 303: The first chip inserts an adjustment request message into an in-band flow control field included in an interface protocol packet, and inserts service data between the first chip and the second chip into a data field in the interface protocol packet.

Specifically, the first chip determines, from the in-band flow control field included in the interface protocol packet, a first field used to transmit adjustment control information and a second field used to transmit adjustment configuration information, and sets the first field to carry an adjustment command, and the second field to carry a first number of links. The first chip inserts the service data between the first chip and the second chip into the data field in the interface protocol packet.

The in-band flow control field included in the interface protocol packet is one custom field included in the interface protocol packet.

The adjustment request message includes the adjustment command and the first number of links, where the first number of links is the number of current links between the first chip and the second chip.

For example, refer to Table 2. The first field used to transmit the adjustment control information occupies two bits, that is, the 5^{th} bit and the 6^{th} bit in the in-band flow control field, and the second field used to transmit the adjustment configuration information occupies five bits, that is, the 0^{th} bit to the 4^{th} bit in the in-band flow control field. The first chip determines, from the in-band flow control field included in the interface protocol packet, the first field used to transmit the adjustment control information and the second field used to transmit the adjustment configuration information, as shown in Table 2, and sets the first field to carry the adjustment command, and the second field to carry the first number of links. The first chip inserts the service data between the first chip and the second chip into the data field in the interface protocol packet.

TABLE 2

| | In-band flow control field | | | | | | | |
|---|---|---|---|---|---|---|---|---|
| Location | bit 7-63 | bit 6 | bit 5 | bit 4 | bit 3 | bit 2 | bit 1 | bit 0 |

| | | | |
|---|---|---|---|
| Bearer | Reserved | First field | Second field |
| informa- | | | |
| tion | | | |

The first field is invariably used to transmit the adjustment control information. When the first chip does not adjust a link, the first chip sets a binary instruction code of the first field to 00 indicating that there is no request/response; when the first chip adjusts a link, the first chip sets the binary instruction code of the first field to 01. The second field is invariably used to transmit the adjustment configuration information, where the second field includes five bits and may carry a maximum of 32 types of adjustment configuration information.

In this example, the first number of links is 5, the binary instruction code of the first field is set to 01, and a binary instruction code of the second field is set to 00101.

Step 304: The first chip sends the interface protocol packet to the second chip by using the unchanged link.

For example, the first chip sends the interface protocol packet that carries an adjustment command 01, a first number 00101 of links, and the service data to the second chip by using the unchanged links Lane1, Lane2, Lane3, and Lane4.

Step 305: The second chip receives the interface protocol packet, and extracts, from the interface protocol packet, the adjustment request message and the service data between the first chip and the second chip.

Specifically, the second chip receives the interface protocol packet, determines, from the in-band flow control field included in the interface protocol packet, the first field used to transmit the adjustment control information and the second field used to transmit the adjustment configuration information, extracts the adjustment command from the first field, extracts the first number of links from the second field, and extracts the service data between the first chip and the second chip from the data field included in the interface protocol packet.

For example, the second chip receives the interface protocol packet, determines, from the in-band flow control field included in the interface protocol packet, the first field used to transmit the adjustment control information and the second field used to transmit the adjustment configuration information, as shown in Table 2, and extracts the adjustment command 01 from the first field, extracts the first number 00101 of links from the second field, and extracts the service data between the first chip and the second chip from the data field included in the interface protocol packet.

Step 306: The second chip synchronizes and aligns the link between the first chip and the second chip according to the adjustment request message, and executes a service between the first chip and the second chip according to the service data between the first chip and the second chip.

Specifically, the second chip compares a second number of links with the first number of links, where the second number of links is the number of links between the first chip and the second chip before the first chip adjusts the link; if the second number of links is smaller than the first number of links, it is determined that the first chip increases a link, and the unchanged link and the newly-added link between the first chip and the second chip are acquired, synchronizes and aligns the newly-added link with the unchanged link, and executes the service between the first chip and the second chip according to the service data between the first chip and the second chip.

If the second number of links is greater than the first number of links, the second chip determines that the first chip reduces a link. After the first chip reduces a link, links between the first chip and the second chip are unchanged links, and the unchanged links are links that have been synchronized and aligned. Therefore, when the first chip reduces a link, no synchronization and alignment is required, and only the service between the first chip and the second chip is executed according to the service data between the first chip and the second chip.

For example, the second chip compares the second number 4 of links with the first number 5 of links, where the second number 4 of links is the number of links between the first chip and the second chip before the first chip adjusts the link; the second chip learns by comparison that the second number 4 of links is smaller than the first number 5 of links, determines that the first chip increases a link, and acquires the unchanged links Lane1, Lane2, Lane3, and Lane4 and the newly-added link Lane5 between the first chip and the second chip; the second chip synchronizes and aligns the newly-added link Lane5 with the unchanged links Lane1, Lane2, Lane3, and Lane4, and executes the service between the first chip and the second chip according to the service data between the first chip and the second chip.

Step 307: The second chip sends a synchronization and alignment response message to the first chip.

Specifically, the second chip determines, from the in-band flow control field included in the interface protocol packet, the first field used to transmit the adjustment control information, sets the first field to carry the synchronization and alignment response message, and sends the interface protocol packet to the first chip by using the unchanged link.

The second chip may send the synchronization and alignment response message to the first chip after synchronization and alignment are complete; the second chip may also send a synchronization response message to the first chip after synchronization is complete, and send an alignment response message to the first chip after alignment is complete.

For example, the second chip determines, from the in-band flow control field included in the interface protocol packet, the first field used to transmit the adjustment control information, as shown in Table 2, and sets the binary instruction code of the first field to 11 that indicates the synchronization and alignment response message, and sends the interface protocol packet to the first chip by using the unchanged links Lane1, Lane2, Lane3, and Lane4.

In this embodiment of the present invention, a first chip increases or reduces a link between the first chip and a second chip; the first chip acquires an unchanged link between the first chip and the second chip; the first chip transmits an adjustment request message by using an in-band flow control field included in a custom field in an interface protocol packet, and sends the adjustment request message to the second chip, and sends, to the second chip, service data between the first chip and the second chip by using the unchanged link, so that the second chip synchronizes and aligns the link between the first chip and the second chip, and the second chip executes a service between the first chip and the second chip. When a link is adjusted, the service data is sent by using the unchanged link; therefore, the service between the first chip and the second chip is not interrupted.

### Embodiment 4

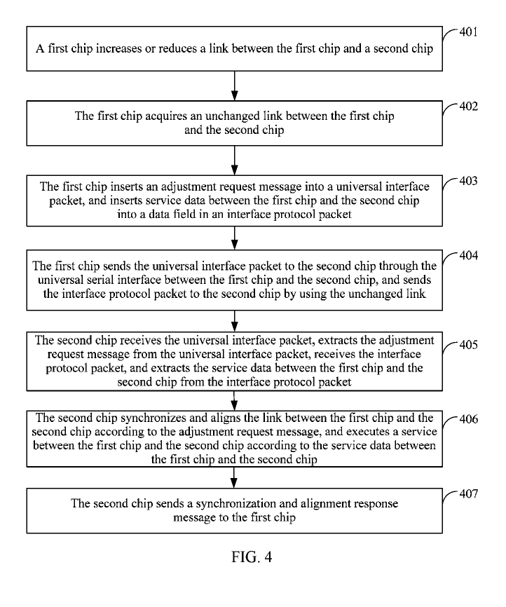

Referring to FIG. 4, this embodiment of the present invention provides a link adjusting method, which uses a universal serial interface between chips to transmit an adjustment request message. The method includes:

Step 401: A first chip increases or reduces a link between the first chip and a second chip.

There is at least one link that connects the first chip and the second chip. When the first chip needs to adjust the link between the first chip and the second chip, the first chip may increase or reduce the link between the first chip and the second chip.

The step may specifically be as follows: When the first chip increases a link between the first chip and the second chip, the first chip increases the link at a pin of the second chip that is not occupied by the first chip, and sequentially numbers the newly-added link according to mapping numbers of the links between the first chip and the second chip before the first chip increases the link; or when the first chip reduces a link between the first chip and the second chip, the first chip acquires a link whose mapping number is the last among links between the first chip and the second chip, and deletes the link whose mapping number is the last.

For example, pins of the first chip and the second chip include pins 0, 1, 2, 3, 4, and 5. Before the first chip increases a link, the mapping numbers of the links between the first chip and the second chip are Lane1, Lane2, Lane3, and Lane4, and these links occupy pins 0, 2, 3, and 4 respectively. Then unoccupied pins are pins 1 and 5 before the first chip increases the link. When the first chip increases one link, the first chip selects either of the unoccupied pins 1 and 5. A description is given by using pin 1 as an example. The first chip increases the one link at the pin 1 and sequentially numbers, according to the mapping numbers Lane1, Lane2, Lane3, and Lane4 of the links between the first chip and the second chip before the first chip increases the link, the newly-added link Lane5; or when the first chip reduces one link, the first chip acquires, among the links with the mapping numbers of Lane1, Lane2, Lane3, and Lane4 between the first chip and the second chip before the link is reduced, the link Lane 4 whose mapping number is the last, and deletes the link Lane4.

Step 402: The first chip acquires an unchanged link between the first chip and the second chip.

When the first chip increases the link between the first chip and the second chip, the unchanged link acquired by the first chip is a link between the first chip and the second chip before the first chip increases the link; when the first chip reduces the link between the first chip and the second chip, the unchanged link acquired by the first chip is the link between the first chip and the second chip after the first chip reduces the link.

For example, when the first chip increases one link, the first chip acquires the unchanged links Lane1, Lane2, Lane3, and Lane4 between the first chip and the second chip; when the first chip reduces one link, the first chip acquires the unchanged links Lane1, Lane2, and Lane3 between the first chip and the second chip.

Step 403: The first chip inserts an adjustment request message into a universal interface packet, and inserts service data between the first chip and the second chip into a data field in an interface protocol packet.

Specifically, the first chip determines, from the universal interface packet, a first field used to transmit adjustment control information and a second field used to transmit adjustment configuration information, and sets the first field to carry an adjustment command, and the second field to carry a first number of links. The first chip inserts the service data between the first chip and the second chip into the data field in the interface protocol packet.

The adjustment request message includes the adjustment command and the first number of links, where the first number of links is the number of current links between the first chip and the second chip.

The universal interface packet is a packet transferred through a universal serial interface between chips, where the universal serial interface may be an out-of-band flow control interface, an SPI (Serial Peripheral Interface), an I2C (Inter-Integrated Circuit, two-wire serial bus), or the like, which are not enumerated herein exhaustively.

For example, a description is given by using the out-of-band flow control interface as the universal serial interface. In this case, the universal interface packet is an out-of-band flow control packet. Refer to Table 3. The first field used to transmit the adjustment control information occupies two data bits, that is, the 5^{th} data bit and the 6^{th} data bit in an out-of-band flow control field, and the second field used to transmit the adjustment configuration information occupies five data bits, that is, the 0^{th} bit to the 4^{th} bit in the out-of-band flow control field. The first chip determines, from the out-of-band flow control interface packet, the first field used to transmit the adjustment control information and the second field used to transmit the adjustment configuration information, as shown in Table 3, and sets the first field to carry the adjustment command, and the second field to carry the first number of links. The first chip inserts the service data between the first chip and the second chip into the data field in the interface protocol packet.

TABLE 3

| | Out-of-band flow control interface packet | | | | | | | |
|---|---|---|---|---|---|---|---|---|
| Location | D7-D15 | D6 | D5 | D4 | D3 | D2 | D1 | D0 |

| | | | |
|---|---|---|---|
| Bearer | Reserved | First field | Second field |
| informa- | | | |
| tion | | | |

The first field is invariably used to transmit the adjustment control information. When the first chip does not adjust link, the first chip sets a binary instruction code of the first field to 00 indicating that there is no request/response; when the first chip adjusts a link, the first chip sets the binary instruction code of the first field to 01. The second field is invariably used to transmit the adjustment configuration information, where the second field includes five data bits and may carry a maximum of 32 types of adjustment configuration information.

In this example, the first number of links is 5, the binary instruction code of the first field is set to 01, and a binary instruction code of the second field is set to 00101.

Step 404: The first chip sends the universal interface packet to the second chip through the universal serial interface between the first chip and the second chip, and sends the interface protocol packet to the second chip by using the unchanged link.

For example, the first chip sends the out-of-band flow control interface packet that carries an adjustment command 01 and a first number 00101 of links to the second chip through the out-of-band flow control interface between the first chip and the second chip, and sends, to the second chip, the interface protocol packet that carries the service data between the first chip and the second chip by using the unchanged links Lane1, Lane2, Lane3, and Lane4.

Step 405: The second chip receives the universal interface packet, extracts the adjustment request message from the universal interface packet, receives the interface protocol packet, and extracts the service data between the first chip and the second chip from the interface protocol packet.

Specifically, the second chip receives the universal interface packet, determines, from the universal interface packet, the first field used to transmit the adjustment control information and the second field used to transmit the adjustment configuration information, extracts the adjustment command from the first field, extracts the first number of links from the second field, receives the interface protocol packet, and extracts the service data between the first chip and the second chip from the data field included in the interface protocol packet.

For example, the second chip receives the out-of-band flow control interface packet, determines, from the out-of-band flow control interface packet, the first field used to transmit the adjustment control information and the second field used to transmit the adjustment configuration information, as shown in Table 3, and extracts the adjustment command 01 from the first field, extracts the first number 00101 of links from the second field, receives the interface protocol packet, and extracts the service data between the first chip and the second chip from the data field included in the interface protocol packet.

Step 406: The second chip synchronizes and aligns the link between the first chip and the second chip according to the adjustment request message, and executes a service between the first chip and the second chip according to the service data between the first chip and the second chip.

Specifically, the second chip compares a second number of links with the first number of links, where the second number of links is the number of links between the first chip and the second chip before the first chip adjusts the link; if the second number of links is smaller than the first number of links, the second chip determines that the first chip increases a link, and the second chip acquires the unchanged link and the newly-added link between the first chip and the second chip, synchronizes and aligns the newly-added link with the unchanged link, and executes the service between the first chip and the second chip according to the service data between the first chip and the second chip.

If the second number of links is greater than the first number of links, the second chip determines that the first chip reduces a link. After the first chip reduces a link, links between the first chip and the second chip are unchanged links, and the unchanged links are links that have been synchronized and aligned. Therefore, when the first chip reduces the link, no synchronization and alignment is required, and only the service between the first chip and the second chip is executed according to the service data between the first chip and the second chip.

For example, the second chip compares the second number 4 of links with the first number 5 of links, where the second number 4 of links is the number of links between the first chip and the second chip before the first chip adjusts the link; the second chip learns by comparison that the second number 4 of links is smaller than the first number 5 of links, determines that the first chip increases a link, and acquires the unchanged links Lane1, Lane2, Lane3, and Lane4 and the newly-added link Lane5 between the first chip and the second chip; the second chip synchronizes and aligns the newly-added link Lane5 with the unchanged links Lane1, Lane2, Lane3, and Lane4, and executes the service between the first chip and the second chip according to the service data between the first chip and the second chip.

Step 407: The second chip sends a synchronization and alignment response message to the first chip.

Specifically, the second chip determines, from the universal interface packet, the first field used to transmit the adjustment control information, sets the first field to carry the synchronization and alignment response message, and sends the interface protocol packet to the first chip through the universal serial interface between the first chip and the second chip.

The second chip may send the synchronization and alignment response message to the first chip after synchronization and alignment are complete; the second chip may also send a synchronization response message to the first chip after synchronization is complete, and send an alignment response message to the first chip after alignment is complete.

For example, the second chip determines, from the out-of-band flow control interface packet, the first field used to transmit the adjustment control information, as shown in Table 3, and sets the binary instruction code of the first field to 11 that indicates the synchronization and alignment response message, and sends the interface protocol packet to the first chip through the out-of-band flow control interface between the first chip and the second chip.

In this embodiment of the present invention, a first chip increases or reduces a link between the first chip and a second chip; the first chip acquires an unchanged link between the first chip and the second chip; the first chip transmits an adjustment request message by using a universal interface packet, sends the adjustment request message to the second chip through a universal serial interface between the first chip and the second chip, and sends, to the second chip, service data between the first chip and the second chip by using the unchanged link, so that the second chip synchronizes and aligns the link between the first chip and the second chip, and the second chip executes a service between the first chip and the second chip. When a link is adjusted, the service data is sent by using the unchanged link; therefore, the service between the first chip and the second chip is not interrupted.

### Embodiment 5

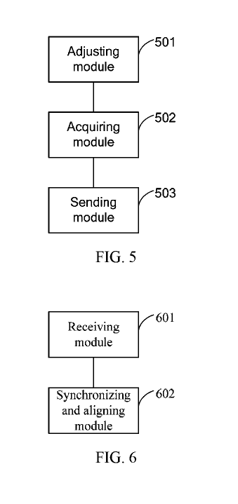

Referring to FIG. 5, this embodiment of the present invention provides a link adjusting apparatus. The apparatus includes:

an adjusting module 501, configured to increase or reduce a link between a first chip and a second chip;

an acquiring module 502, configured to acquire an unchanged link between the first chip and the second chip; and

a sending module 503, configured to send an adjustment request message to the second chip, and send, to the second chip, service data between the first chip and the second chip by using the unchanged link, so that the second chip synchronizes and aligns the link between the first chip and the second chip, and the second chip executes a service between the first chip and the second chip.

The sending module 503 is configured to insert the adjustment request message into a custom field in an interface protocol packet, insert the service data between the first chip and the second chip into a data field in the interface protocol packet, and send the interface protocol packet to the second chip by using the unchanged link.

The sending module 503 includes:

a sending unit, configured to send the adjustment request message to the second chip through a universal serial interface between the first chip and the second chip; and

an inserting and sending unit, configured to insert the service data between the first chip and the second chip into the data field in the interface protocol packet, and send the interface protocol packet to the second chip by using the unchanged link.

The custom field includes a multipurpose field and an in-band flow control field, and the adjustment request message includes an adjustment command and a first number of links, where the first number of links is the number of current links between the first chip and the second chip.

The sending module 503 includes:

a first determining and setting unit, configured to determine, from the multipurpose field included in the interface protocol packet, a first field used to transmit adjustment control information and a second field used to transmit adjustment configuration information, and set the first field to carry the adjustment command, and the second field to carry the first number of links; or

a second determining and setting unit, configured to determine, from the in-band flow control field included in the interface protocol packet, a first field used to transmit adjustment control information and a second field used to transmit adjustment configuration information, and set the first field to carry the adjustment command, and the second field to carry the first number of links.

Further, the apparatus further includes:

a first receiving module, configured to receive, by using the unchanged link, the interface protocol packet sent by the second chip, determine, from the multipurpose field included in the interface protocol packet, the first field used to transmit the adjustment control information, and extract a synchronization and alignment response message from the first field; or

a second receiving module, configured to receive, by using the unchanged link, the interface protocol packet sent by the second chip, determine, from the in-band flow control field included in the interface protocol packet, the first field used to transmit the adjustment control information, and extract a synchronization and alignment response message from the first field; or

a third receiving module, configured to receive, through the universal serial interface between the first chip and the second chip, a synchronization and alignment response message sent by the second chip.

In this embodiment of the present invention, a first chip increases or reduces a link between the first chip and a second chip; the first chip acquires an unchanged link between the first chip and the second chip; the first chip sends an adjustment request message to the second chip, and sends, to the second chip, service data between the first chip and the second chip by using the unchanged link, so that the second chip synchronizes and aligns the link between the first chip and the second chip, and the second chip executes a service between the first chip and the second chip. When a link is adjusted, the service data is sent by using the unchanged link; therefore, the service between the first chip and the second chip is not interrupted.

### Embodiment 6

Referring to FIG. 6, this embodiment of the present invention provides a link adjusting apparatus. The apparatus includes:

a receiving module 601, configured to: when a first chip increases or reduces a link between the first chip and a second chip, receive an adjustment request message sent by the first chip, and receive service data between the first chip and the second chip by using the unchanged link, where the service data is sent by the first chip; and

a synchronizing and aligning module 602, configured to synchronize and align the link between the first chip and the second chip according to the adjustment request message, and execute a service between the first chip and the second chip according to the service data between the first chip and the second chip.

The receiving module 601 is configured to receive, from the unchanged link, an interface protocol packet sent by the first chip, and extract, from the interface protocol packet, the adjustment request message and the service data between the first chip and the second chip.

The receiving module 601 includes:

a first determining and extracting unit, configured to determine, from a multipurpose field included in the interface protocol packet, a first field used to transmit adjustment control information and a second field used to transmit adjustment configuration information, extract an adjustment command from the first field, extract a first number of links from the second field, and extract the service data between the first chip and the second chip from a data field included in the interface protocol packet; or

a second determining and extracting unit, configured to determine, from an in-band flow control field included in the interface protocol packet, a first field used to transmit adjustment control information and a second field used to transmit adjustment configuration information, extract an adjustment command from the first field, extract a first number of links from the second field, and extract the service data between the first chip and the second chip from a data field included in the interface protocol packet.

The receiving module 601 includes:

a receiving unit, configured to receive, through a universal serial interface between the first chip and the second chip, the adjustment request message sent by the first chip; and

a receiving and extracting unit, configured to receive, by using the unchanged link, the interface protocol packet sent by the first chip, and extract the service data between the first chip and the second chip from the data field included in the interface protocol packet.

The synchronizing and aligning module 602 includes:

a comparing unit, configured to compare a second number of links with the first number of links, where the second number of links is the number of links between the first chip and the second chip before the first chip adjusts the link;

an acquiring unit, configured to: if the second number of links is smaller than the first number of links, determine that the first chip increases a link, and acquire the unchanged link and a newly-added link between the first chip and the second chip; and

a synchronizing and aligning unit, configured to synchronize and align the newly-added link with the unchanged link.

Further, the apparatus further includes:

a first setting and sending module, configured to determine, from the multipurpose field included in the interface protocol packet, the first field used to transmit the adjustment control information, set the first field to carry a synchronization and alignment response message, and send the interface protocol packet to the first chip by using the unchanged link; or

a second setting and sending module, configured to determine, from the in-band flow control field included in the interface protocol packet, the first field used to transmit the adjustment control information, set the first field to carry a synchronization and alignment response message, and send the interface protocol packet to the first chip by using the unchanged link; or

a sending module, configured to send a synchronization and alignment response message through the universal serial interface between the first chip and the second chip.

In this embodiment of the present invention, a first chip increases or reduces a link between the first chip and a second chip; the first chip acquires an unchanged link between the first chip and the second chip; the first chip sends an adjustment request message to the second chip, and sends, to the second chip service data between the first chip and the second chip by using the unchanged link, so that the second chip synchronizes and aligns the link between the first chip and the second chip, and the second chip executes a service between the first chip and the second chip. When a link is adjusted, the service data is sent by using the unchanged link; therefore, the service between the first chip and the second chip is not interrupted.

A person of ordinary skill in the art may understand that all or a part of the steps of the embodiments may be implemented by hardware or a program instructing relevant hardware. The program may be stored in a computer readable storage medium. The storage medium may include: a read-only memory, a magnetic disk, or an optical disc.

The foregoing descriptions are merely exemplary embodiments of the present invention, but are not intended to limit the present invention. Any modification, equivalent replacement, and improvement made without departing from the spirit and principle of the present invention shall fall within the protection scope of the present invention.

1. A link adjusting method, wherein the method comprises:
increasing or reducing, by a first chip, a number of links between the first chip and a second chip;
determining, by the first chip, an unchanged link between the first chip and the second chip; and
sending, by the first chip, an adjustment request message to the second chip using the unchanged link; and sending, by the first chip, to the second chip, service data using the unchanged link;
wherein the second chip is configured to synchronize and align the links between the first chip and the second chip.

2. The method according to claim 1, further comprising:
inserting, by the first chip, the adjustment request message into a custom field in an interface protocol packet; and inserting the service data into a data field in the interface protocol packet;
wherein sending the adjustment request message and the service data to the second chip comprises sending the interface protocol packet to the second chip.

3. The method according to claim 1, wherein the unchanged link comprises
a universal serial interface between the first chip and the second chip; and
wherein the method further comprises: inserting, by the first chip, the service data into a data field in an interface protocol packet; and
wherein sending the service data to the second chip comprises sending the interface protocol packet to the second chip.

4. The method according to claim 2, wherein the custom field comprises a multipurpose field and an in-band flow control field, and the adjustment request message comprises an adjustment command and a first number of links, wherein the first number of links is the number of current links between the first chip and the second chip; and
Wherein inserting the adjustment request message into the custom field in the interface protocol packet comprises:
determining, by the first chip, from the multipurpose field or from the in-band flow control field, a first field used to transmit adjustment control information and a second field used to transmit adjustment configuration information, and setting the first field to carry the adjustment command and the second field to carry the first number of links.

5. The method according to claim 1, wherein the method further comprises:
receiving, by the first chip, via the unchanged link, an interface protocol packet from the second chip; determining, from a multipurpose field or an in-band control field of the interface protocol packet, a first field used to transmit the adjustment control information; and extracting a synchronization and alignment response message from the first field; or
receiving, by the first chip, via a universal serial interface between the first chip and the second chip, a synchronization and alignment response message from the second chip.

6. A link adjusting method, wherein the method comprises:
receiving, by a second chip, an adjustment request message from a first chip, and receiving, by the second chip, service data from the first chip using an unchanged link, wherein the unchanged link is one of a number of links between the first chip and the second link that was not increased or reduced by the first chip; and
synchronizing and aligning, by the second chip, the links between the first chip and the second chip based on the adjustment request message.

7. The method according to claim 6, wherein the adjustment request message and the service data
are received as part of an interface protocol packet; and
wherein the method further comprises: extracting, from the interface protocol packet, the adjustment request message and the service data.

8. The method according to claim 7, wherein the extracting comprises:
determining, by the second chip, from a multipurpose field or an in-band flow control field of the interface protocol packet, a first field used to transmit adjustment control information and a second field used to transmit adjustment configuration information, extracting an adjustment command from the first field, extracting a first number of links from the second field, and extracting the service data from a data field of the interface protocol packet.

9. The method according to claim 6, wherein the adjustment request message the service data
are received through a universal serial interface between the first chip and the second chip and as part of
an interface protocol packet; and
wherein the method further comprises: extracting the service data from a data field of the interface protocol packet.

10. The method according to claim 8, wherein the synchronizing and aligning comprises:
comparing a second number of links with the first number of links, wherein the second number of links is the number of links between the first chip and the second chip before the first chip increases or reduces the number of links between the first chip and the second chip and wherein the first number of links is the number of links between the first chip and the second chip after the first chip increases or reduces the number of links between the first chip and the second chip;
based on the second number of links being smaller than the first number of links, determining that the first chip increased the number of links and determining the unchanged link and a newly-added link between the first chip and the second chip; and
synchronizing and aligning the newly-added link with the unchanged link.

11. The method according to claim 6, wherein, after the synchronizing and aligning, the method further comprises:
determining, by the second chip from a multipurpose field or an in-band flow control field of an interface protocol packet, a first field used to transmit adjustment control information, setting the first field to carry a synchronization and alignment response message, and sending the interface protocol packet to the first chip using the unchanged link; or
sending, by the second chip, a synchronization and alignment response message through a universal serial interface between the first chip and the second chip.

12-22. (canceled)

23. A first chip, comprising a non-transitory processor-readable medium having processor-executable instructions stored thereon for link adjustment, the processor-executable instructions comprising instructions for:
increasing or reducing, by the first chip, a number of links between the first chip and a second chip;
determining, by the first chip, an unchanged link between the first chip and the second chip; and
sending, by the first chip, an adjustment request message to the second chip using the unchanged link; and sending, by the first chip, to the second chip, service data using the unchanged link;
wherein the second chip is configured to synchronize and align the links between the first chip and the second chip.

24. The first chip according to claim 23, wherein the processor-executable instructions further comprise instructions for:
inserting, by the first chip, the adjustment request message into a custom field in an interface protocol packet; and inserting the service data into a data field in the interface protocol packet;
wherein sending the adjustment request message and the service data to the second chip comprises sending the interface protocol packet to the second chip.

25. The first chip according to claim 23, wherein the unchanged link comprises a universal serial interface between the first chip and the second chip; and
wherein the processor-executable instructions further comprise instructions for: inserting, by the first chip, the service data into a data field in an interface protocol packet; and
wherein sending the service data to the second chip comprises sending the interface protocol packet to the second chip.

26. The first chip according to claim 24, wherein the custom field comprises a multipurpose field and an in-band flow control field, and the adjustment request message comprises an adjustment command and a first number of links, wherein the first number of links is the number of current links between the first chip and the second chip; and
wherein inserting the adjustment request message into the custom field in the interface protocol packet comprises:
determining, by the first chip, from the multipurpose field or from the in-band flow control field, a first field used to transmit adjustment control information and a second field used to transmit adjustment configuration information, and setting the first field to carry the adjustment command and the second field to carry the first number of links.

27. The first chip according to claim 23, wherein the processor-executable instructions further comprise instructions for:
receiving, by the first chip, via the unchanged link, an interface protocol packet from the second chip; determining, from a multipurpose field or an in-band control field of the interface protocol packet, a first field used to transmit the adjustment control information; and extracting a synchronization and alignment response message from the first field; or
receiving, by the first chip, via a universal serial interface between the first chip and the second chip, a synchronization and alignment response message from the second chip.

28. A second chip, comprising a non-transitory processor-readable medium having processor-executable instructions stored thereon for link adjustment, the processor-executable instructions comprising instructions for:
receiving, by a second chip, an adjustment request message from a first chip, and receiving, by the second chip, service data from the first chip using an unchanged link, wherein the unchanged link is one of a number of links between the first chip and the second link that was not increased or reduced by the first chip; and
synchronizing and aligning, by the second chip, the links between the first chip and the second chip based on the adjustment request message.

29. The second chip according to claim 28, wherein the adjustment request message and the service data are received as part of an interface protocol packet; and
wherein the processor-executable instructions further comprise instructions for: extracting, from the interface protocol packet, the adjustment request message and the service data.

30. The second chip according to claim 29, wherein the extracting comprises:
determining, by the second chip, from a multipurpose field or an in-band flow control field of the interface protocol packet, a first field used to transmit adjustment control information and a second field used to transmit adjustment configuration information, extracting an adjustment command from the first field, extracting a first number of links from the second field, and extracting the service data from a data field of the interface protocol packet.

31. The second chip according to claim 28, wherein the adjustment request message the service data are received through a universal serial interface between the first chip and the second chip and as part of an interface protocol packet; and
wherein the processor-executable instructions further comprise instructions for: extracting the service data from a data field of the interface protocol packet.

32. The second chip according to claim 30, wherein the synchronizing and aligning comprises:
comparing a second number of links with the first number of links, wherein the second number of links is the number of links between the first chip and the second chip before the first chip increases or reduces the number of links between the first chip and the second chip and wherein the first number of links is the number of links between the first chip and the second chip after the first chip increases or reduces the number of links between the first chip and the second chip;
based on the second number of links being smaller than the first number of links, determining that the first chip increased the number of links and determining the unchanged link and a newly-added link between the first chip and the second chip; and
synchronizing and aligning the newly-added link with the unchanged link.

33. The second chip according to claim 28, wherein the processor-executable instructions further comprise instructions for:
determining, by the second chip from a multipurpose field or an in-band flow control field of an interface protocol packet, a first field used to transmit adjustment control information, setting the first field to carry a synchronization and alignment response message, and sending the interface protocol packet to the first chip using the unchanged link; or
sending, by the second chip, a synchronization and alignment response message through a universal serial interface between the first chip and the second chip.
